(19) United States
(12) Patent Application Publication
(10) Pub. No.: US 2020/0128720 A1
(43) Pub. Date: Apr. 30, 2020

(54) SYSTEMS AND METHODS FOR IDENTIFYING AND UTILIZING TESTING LOCATIONS IN AGRICULTURAL FIELDS

(71) Applicant: The Climate Corporation, San Francisco, CA (US)

(72) Inventors: Nicholas Cizek, Stanford, CA (US); Moslem Ladoni, Dublin, CA (US); Daniel Williams, Sacramento, CA (US)

(21) Appl. No.: 16/661,956

(22) Filed: Oct. 23, 2019

Related U.S. Application Data
(60) Provisional application No. 62/750,181, filed on Oct. 24, 2018.

(51) Int. Cl. A01B 79/00; G06N 5/04; G06N 20/00

(52) U.S. Cl. CPC A01B 79/005; G06N 20/00; G06N 5/04

(57) ABSTRACT

Systems and methods for implementing a trial in one or more fields is provided. According to an embodiment, an agricultural intelligence computer system identifies a plurality of sets of adjacent locations in a field and computes a difference value between the locations. The system uses the different values for the plurality of sets of adjacent locations to determine a short length variability score. The system may then use the short length variability score to identify fields for implementing a trial and/or locations within a field to implement the trial. In embodiments, the system uses a grid overlay which the system orients based on header information received from agricultural implements. In embodiments, the system alters the grid overlay to increase a number of testing locations on the agricultural field and/or within different management zones.

### BENEFIT CLAIM

This application claims the benefit under 35 U.S.C. § 119 of U.S. Provisional Application No. 62/750,181, filed Oct. 24, 2018, the entire contents of which are incorporated by reference as if fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2015-2017 The Climate Corporation.

### FIELD OF THE DISCLOSURE

The present disclosure relates to digital computer modeling and tracking of agricultural fields. Specifically, the present disclosure relates to identifying locations for implementing particular practices in an agricultural field and causing agricultural implements to execute the particular practices in the agricultural field.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Field managers are faced with a wide variety of decisions to make with respect to the management of agricultural fields. These decisions range from determining what crop to plant, which type of seed to plant for the crop, when to harvest a crop, whether to perform tillage, irrigation, application of pesticides, including fungicides and herbicides, and application of fertilizer, and what types of pesticides or fertilizers to apply.

Often, improvements may be made to the management practices of a field by using different hybrid seeds or different seed varieties, applying different products to the field, or performing different management activities on the field. These improvements may not be readily identifiable to a field manager working with only information about their own field. Additionally, even when made aware of better practices, a field manager may not be able to determine whether a new practice is beneficial over a prior practice.

In order to determine if a new practice produces better results than a prior practice, a field manager may devote a portion of an agricultural field to trials where one or more parts of the agricultural field receives different management practices than other parts of the agricultural field. By implementing trials on a part of the agricultural field, a field manager is able to continue utilizing the agricultural field in a prior effective manner while testing different practices to determine if they would have improved results.

One issue with implementing these trials is that it is not always clear to a field manager where to best place, orient, or size trial locations for the highest efficiency use of the agricultural field. Thus, a field manager's trial practices may tie up a large portion of the field in strip trials to produce a set of results that could have been produced with the same level of statistical significance while utilizing a smaller portion of the agricultural field. Additionally, field manager generated trials may require extra passes of the agricultural implements, thereby reducing the efficiency of the implements executing the trials on the field.

Thus, there is a need for a system which utilizes field data to identify testing locations, sizes, and/or orientations for implementing a trial.

### SUMMARY

The appended claims may serve as a summary of the disclosure.

### BRIEF DESCRIPTION OF THE DRAWINGS

In the drawings:

FIG. 1 illustrates an example computer system that is configured to perform the functions described herein, shown in a field environment with other apparatus with which the system may interoperate.

FIG. 2 illustrates two views of an example logical organization of sets of instructions in main memory when an example mobile application is loaded for execution.

FIG. 3 illustrates a programmed process by which the agricultural intelligence computer system generates one or more preconfigured agricultural models using agricultural data provided by one or more data sources.

FIG. 4 is a block diagram that illustrates a computer system upon which an embodiment of the invention may be implemented.

FIG. 5 depicts an example embodiment of a timeline view for data entry.

FIG. 6 depicts an example embodiment of a spreadsheet view for data entry.

FIG. 7 depicts a method for modeling short length variability within a field.

FIG. 8 depicts an example of a grid overlay on a map used for computing short length yield variability.

FIG. 9 depicts an example method of varying testing locations within a preset grid to maximize a number of testing locations.

### DETAILED DESCRIPTION

In the following description, for the purposes of explanation, numerous specific details are set forth in order to provide a thorough understanding of the present disclosure. It will be apparent, however, that embodiments may be practiced without these specific details. In other instances, well-known structures and devices are shown in block diagram form in order to avoid unnecessarily obscuring the present disclosure. Embodiments are disclosed in sections according to the following outline:
1. GENERAL OVERVIEW
2. EXAMPLE AGRICULTURAL INTELLIGENCE COMPUTER SYSTEM
   2.1. STRUCTURAL OVERVIEW
   2.2. APPLICATION PROGRAM OVERVIEW
   2.3. DATA INGEST TO THE COMPUTER SYSTEM
   2.4. PROCESS OVERVIEW—AGRONOMIC MODEL TRAINING
   2.5. IMPLEMENTATION EXAMPLE—HARDWARE OVERVIEW
3. TRIAL GENERATION
   3.1. SHORT LENGTH YIELD VARIATION
   3.2. MODELING VARIATION
   3.3. SELECTING FIELDS BASED ON SHORT LENGTH VARIABILITY
   3.4. SELECTING AND SIZING TESTING LOCATIONS
   3.5. DETERMINING TESTING LOCATION ORIENTATION
   3.6. SELECTING FROM GRID LOCATIONS
   3.7. PRESCRIPTION MAPS AND SCRIPTS
   3.8. BENEFITS OF CERTAIN EMBODIMENTS

### 1. GENERAL OVERVIEW

Systems and methods for determining locations, sizes, and/or orientations of testing locations are described herein. In an embodiment, a system receives a map of an agricultural field and data relating to the agricultural field, such as as-applied data received from an agricultural implement. The system generates a grid overlay for the map of the agricultural field. The system may additionally orient the grid based on received as-applied data or image data. The system computes short length variability for the agricultural field based on measured or modeled yield variation between grid cells in a plurality of pairs of adjacent grid cells. Based on the short length yield variability, the system selects a field for implementing a trial and/or identifies locations within a field for implementing the trial. Methods may additionally include augmenting the grid overlay to increase a number of available testing locations in a field and/or management zone.

In an embodiment, a method comprises receiving a map of an agricultural field; generating a grid overlay for the map of the agricultural field and using the grid overlay and the map to generate a gridded map; selecting a plurality of adjacent grid cells from the gridded map; for each set of adjacent grid cells, computing a difference in average yield between the adjacent cells; determining a short length variability for the agricultural field based, at least in part, on the difference in average yield for each set of adjacent grid cells.

### 2. EXAMPLE AGRICULTURAL INTELLIGENCE COMPUTER SYSTEM

### 2.1 Structural Overview

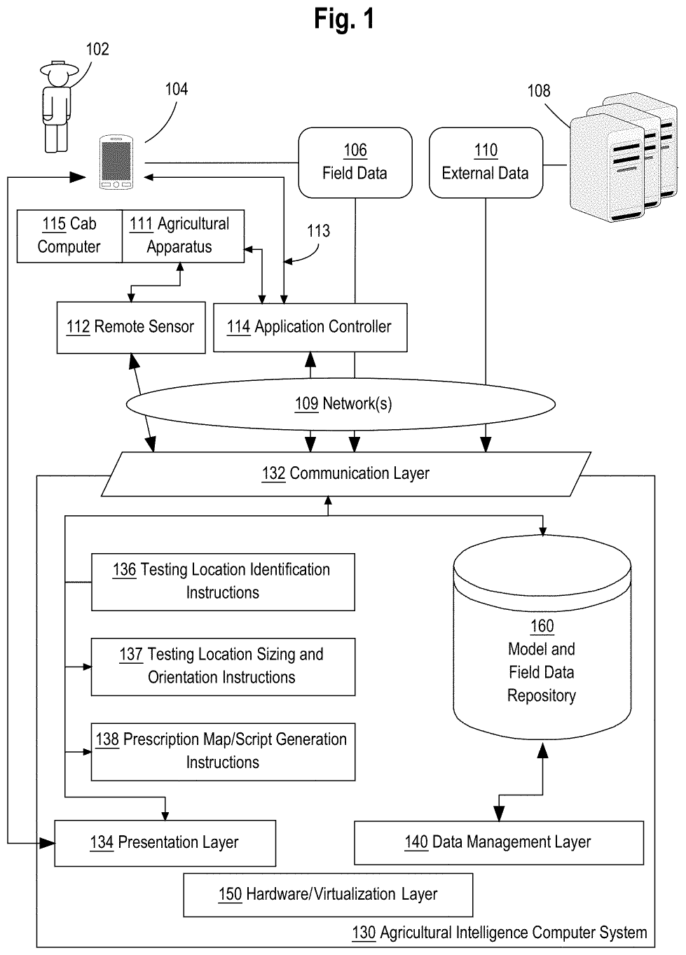

FIG. 1 illustrates an example computer system that is configured to perform the functions described herein, shown in a field environment with other apparatus with which the system may interoperate. In one embodiment, a user 102 owns, operates or possesses a field manager computing device 104 in a field location or associated with a field location such as a field intended for agricultural activities or a management location for one or more agricultural fields. The field manager computer device 104 is programmed or configured to provide field data 106 to an agricultural intelligence computer system 130 via one or more networks 109.

Examples of field data 106 include (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticides, microbials, other substances or mixtures of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), and (k) soil, seed, crop phenology, pest and disease reporting, and predictions sources and databases.

A data server computer 108 is communicatively coupled to agricultural intelligence computer system 130 and is programmed or configured to send external data 110 to agricultural intelligence computer system 130 via the network(s) 109. The external data server computer 108 may be owned or operated by the same legal person or entity as the agricultural intelligence computer system 130, or by a different person or entity such as a government agency, non-governmental organization (NGO), and/or a private data service provider. Examples of external data include weather data, imagery data, soil data, or statistical data relating to crop yields, among others. External data 110 may consist of the same type of information as field data 106. In some embodiments, the external data 110 is provided by an external data server 108 owned by the same entity that owns and/or operates the agricultural intelligence computer system 130. For example, the agricultural intelligence computer system 130 may include a data server focused exclusively on a type of data that might otherwise be obtained from third party sources, such as weather data. In some embodiments, an external data server 108 may actually be incorporated within the system 130.

An agricultural apparatus 111 may have one or more remote sensors 112 fixed thereon, which sensors are communicatively coupled either directly or indirectly via agricultural apparatus 111 to the agricultural intelligence computer system 130 and are programmed or configured to send sensor data to agricultural intelligence computer system 130. Examples of agricultural apparatus 111 include tractors, combines, harvesters, planters, trucks, fertilizer equipment, aerial vehicles including unmanned aerial vehicles, and any other item of physical machinery or hardware, typically mobile machinery, and which may be used in tasks associated with agriculture. In some embodiments, a single unit of apparatus 111 may comprise a plurality of sensors 112 that are coupled locally in a network on the apparatus; controller area network (CAN) is example of such a network that can be installed in combines, harvesters, sprayers, and cultivators. Application controller 114 is communicatively coupled to agricultural intelligence computer system 130 via the network(s) 109 and is programmed or configured to receive one or more scripts that are used to control an operating parameter of an agricultural vehicle or implement from the agricultural intelligence computer system 130. For instance, a controller area network (CAN) bus interface may be used to enable communications from the agricultural intelligence computer system 130 to the agricultural apparatus 111, such as how the CLIMATE FIELDVIEW DRIVE, available from The Climate Corporation, San Francisco, Calif., is used. Sensor data may consist of the same type of information as field data 106. In some embodiments, remote sensors 112 may not be fixed to an agricultural apparatus 111 but may be remotely located in the field and may communicate with network 109.

The apparatus 111 may comprise a cab computer 115 that is programmed with a cab application, which may comprise a version or variant of the mobile application for device 104 that is further described in other sections herein. In an embodiment, cab computer 115 comprises a compact computer, often a tablet-sized computer or smartphone, with a graphical screen display, such as a color display, that is mounted within an operator's cab of the apparatus 111. Cab computer 115 may implement some or all of the operations and functions that are described further herein for the mobile computer device 104.

The network(s) 109 broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. The sensors 112, controller 114, external data server computer 108, and other elements of the system each comprise an interface compatible with the network(s) 109 and are programmed or configured to use standardized protocols for communication across the networks such as TCP/IP, Bluetooth, CAN protocol and higher-layer protocols such as HTTP, TLS, and the like.

Agricultural intelligence computer system 130 is programmed or configured to receive field data 106 from field manager computing device 104, external data 110 from external data server computer 108, and sensor data from remote sensor 112. Agricultural intelligence computer system 130 may be further configured to host, use or execute one or more computer programs, other software elements, digitally programmed logic such as FPGAs or ASICs, or any combination thereof to perform translation and storage of data values, construction of digital models of one or more crops on one or more fields, generation of recommendations and notifications, and generation and sending of scripts to application controller 114, in the manner described further in other sections of this disclosure.

In an embodiment, agricultural intelligence computer system 130 is programmed with or comprises a communication layer 132, presentation layer 134, data management layer 140, hardware/virtualization layer 150, and model and field data repository 160. “Layer,” in this context, refers to any combination of electronic digital interface circuits, microcontrollers, firmware such as drivers, and/or computer programs or other software elements.

Communication layer 132 may be programmed or configured to perform input/output interfacing functions including sending requests to field manager computing device 104, external data server computer 108, and remote sensor 112 for field data, external data, and sensor data respectively. Communication layer 132 may be programmed or configured to send the received data to model and field data repository 160 to be stored as field data 106.

Presentation layer 134 may be programmed or configured to generate a graphical user interface (GUI) to be displayed on field manager computing device 104, cab computer 115 or other computers that are coupled to the system 130 through the network 109. The GUI may comprise controls for inputting data to be sent to agricultural intelligence computer system 130, generating requests for models and/or recommendations, and/or displaying recommendations, notifications, models, and other field data.

Data management layer 140 may be programmed or configured to manage read operations and write operations involving the repository 160 and other functional elements of the system, including queries and result sets communicated between the functional elements of the system and the repository. Examples of data management layer 140 include JDBC, SQL server interface code, and/or HADOOP interface code, among others. Repository 160 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data 106 is not provided directly to the agricultural intelligence computer system via one or more agricultural machines or agricultural machine devices that interacts with the agricultural intelligence computer system, the user may be prompted via one or more user interfaces on the user device (served by the agricultural intelligence computer system) to input such information. In an example embodiment, the user may specify identification data by accessing a map on the user device (served by the agricultural intelligence computer system) and selecting specific CLUs that have been graphically shown on the map. In an alternative embodiment, the user 102 may specify identification data by accessing a map on the user device (served by the agricultural intelligence computer system 130) and drawing boundaries of the field over the map. Such CLU selection or map drawings represent geographic identifiers. In alternative embodiments, the user may specify identification data by accessing field identification data (provided as shape files or in a similar format) from the U. S. Department of Agriculture Farm Service Agency or other source via the user device and providing such field identification data to the agricultural intelligence computer system.

In an example embodiment, the agricultural intelligence computer system 130 is programmed to generate and cause displaying a graphical user interface comprising a data manager for data input. After one or more fields have been identified using the methods described above, the data manager may provide one or more graphical user interface widgets which when selected can identify changes to the field, soil, crops, tillage, or nutrient practices. The data manager may include a timeline view, a spreadsheet view, and/or one or more editable programs.

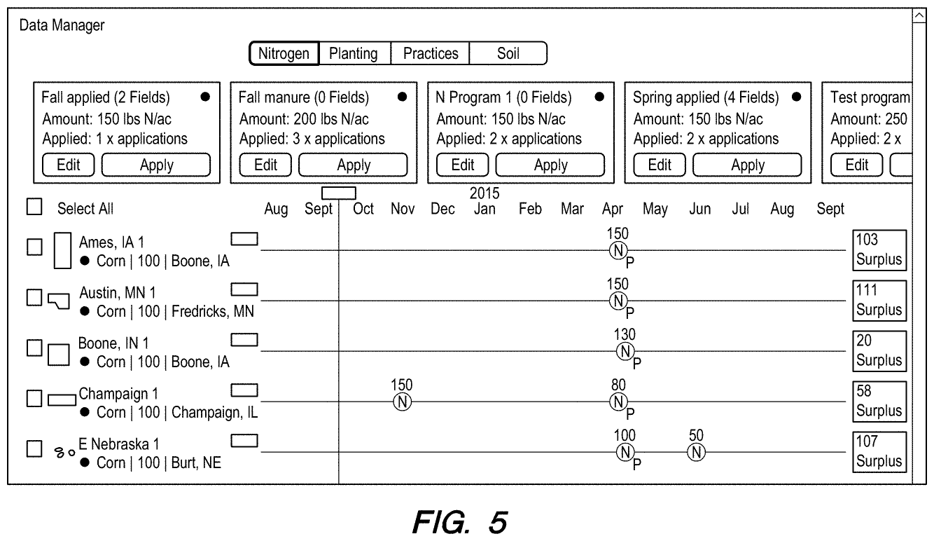

FIG. 5 depicts an example embodiment of a timeline view for data entry. Using the display depicted in FIG. 5, a user computer can input a selection of a particular field and a particular date for the addition of event. Events depicted at the top of the timeline may include Nitrogen, Planting, Practices, and Soil. To add a nitrogen application event, a user computer may provide input to select the nitrogen tab. The user computer may then select a location on the timeline for a particular field in order to indicate an application of nitrogen on the selected field. In response to receiving a selection of a location on the timeline for a particular field, the data manager may display a data entry overlay, allowing the user computer to input data pertaining to nitrogen applications, planting procedures, soil application, tillage procedures, irrigation practices, or other information relating to the particular field. For example, if a user computer selects a portion of the timeline and indicates an application of nitrogen, then the data entry overlay may include fields for inputting an amount of nitrogen applied, a date of application, a type of fertilizer used, and any other information related to the application of nitrogen.

In an embodiment, the data manager provides an interface for creating one or more programs. “Program,” in this context, refers to a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 5, the top two timelines have the “Spring applied” program selected, which includes an application of 150 lbs N/ac in early April. The data manager may provide an interface for editing a program. In an embodiment, when a particular program is edited, each field that has selected the particular program is edited. For example, in FIG. 5, if the “Spring applied” program is edited to reduce the application of nitrogen to 130 lbs N/ac, the top two fields may be updated with a reduced application of nitrogen based on the edited program.

In an embodiment, in response to receiving edits to a field that has a program selected, the data manager removes the correspondence of the field to the selected program. For example, if a nitrogen application is added to the top field in FIG. 5, the interface may update to indicate that the “Spring applied” program is no longer being applied to the top field. While the nitrogen application in early April may remain, updates to the “Spring applied” program would not alter the April application of nitrogen.

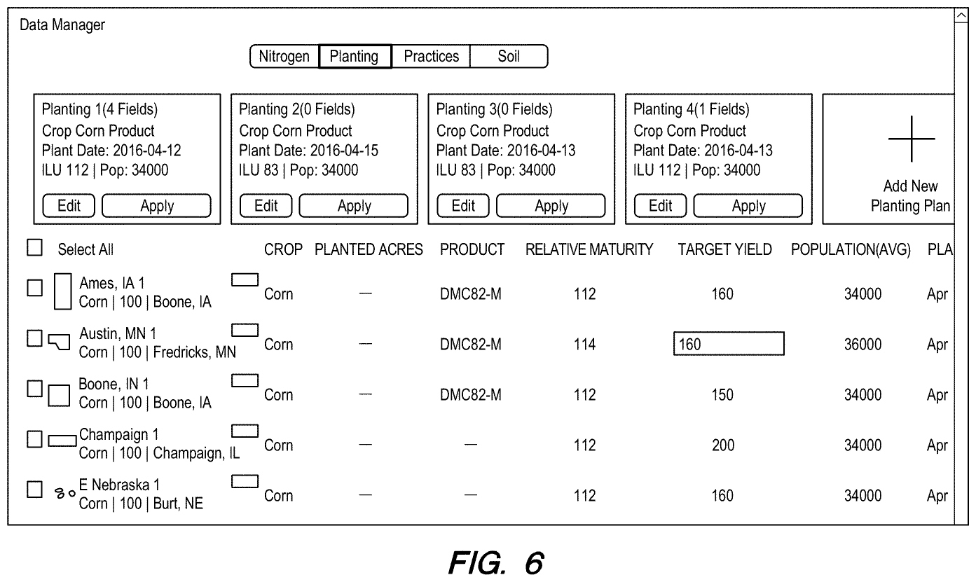

FIG. 6 depicts an example embodiment of a spreadsheet view for data entry. Using the display depicted in FIG. 6, a user can create and edit information for one or more fields. The data manager may include spreadsheets for inputting information with respect to Nitrogen, Planting, Practices, and Soil as depicted in FIG. 6. To edit a particular entry, a user computer may select the particular entry in the spreadsheet and update the values. For example, FIG. 6 depicts an in-progress update to a target yield value for the second field. Additionally, a user computer may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In an embodiment, model and field data is stored in model and field data repository 160. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

In an embodiment, each of testing location identification instructions 136, testing location sizing and orientation instructions 137, and prescription map/script generation instructions 138 comprises a set of one or more pages of main memory, such as RAM, in the agricultural intelligence computer system 130 into which executable instructions have been loaded and which when executed cause the agricultural intelligence computing system to perform the functions or operations that are described herein with reference to those modules. For example, testing location identification instructions may comprise a set of pages in RAM that contain instructions which when executed cause performing the testing location identification functions that are described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, each of testing location identification instructions 136, testing location sizing and orientation instructions 137, and prescription map/script generation instructions 138 also may represent one or more files or projects of source code that are digitally stored in a mass storage device such as non-volatile RAM or disk storage, in the agricultural intelligence computer system 130 or a separate repository system, which when compiled or interpreted cause generating executable instructions which when executed cause the agricultural intelligence computing system to perform the functions or operations that are described herein with reference to those modules. In other words, the drawing figure may represent the manner in which programmers or software developers organize and arrange source code for later compilation into an executable, or interpretation into bytecode or the equivalent, for execution by the agricultural intelligence computer system 130.

Testing location identification instructions 136 comprise a set of computer readable instructions which, when executed by one or more processors, cause the agricultural intelligence computer system to identify locations for implementing the testing locations. Testing location sizing and orientation instructions 137 comprise a set of computer readable instructions which, when executed by one or more processors, cause the agricultural intelligence computer system to determine sizes and orientations for testing locations. Prescription map/script generation instructions 138 comprise a set of computer readable instructions which, when executed by one or more processors, cause the agricultural intelligence computer system to generate prescription maps and/or executable scripts which include trials being implemented in the testing locations.

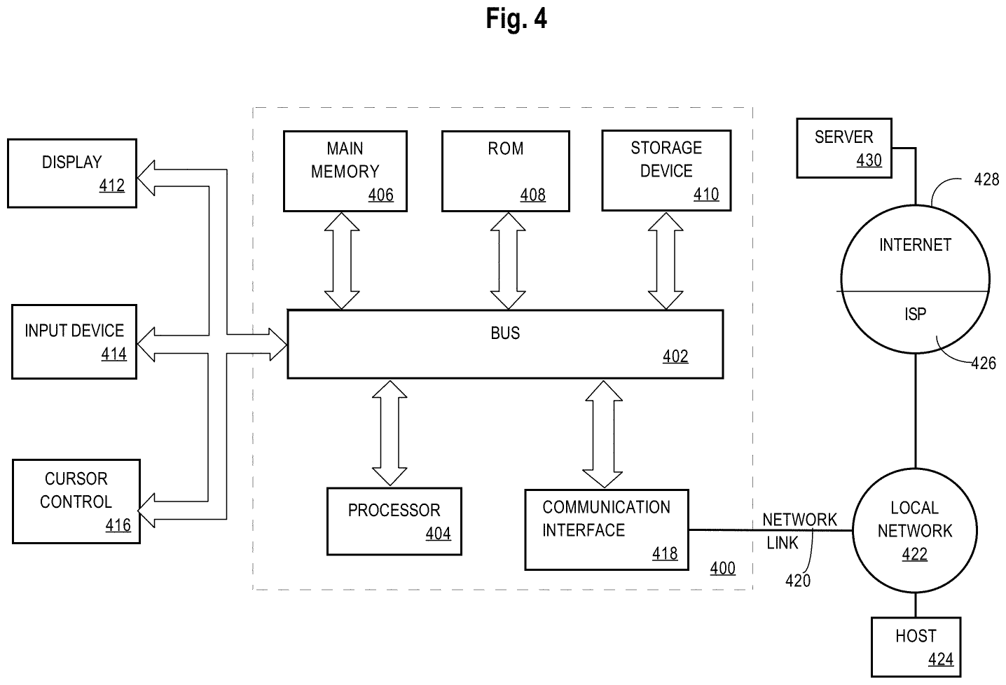

Hardware/virtualization layer 150 comprises one or more central processing units (CPUs), memory controllers, and other devices, components, or elements of a computer system such as volatile or non-volatile memory, non-volatile storage such as disk, and I/O devices or interfaces as illustrated and described, for example, in connection with FIG. 4. The layer 150 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 104 associated with different users. Further, the system 130 and/or external data server computer 108 may be implemented using two or more processors, cores, clusters, or instances of physical machines or virtual machines, configured in a discrete location or co-located with other elements in a datacenter, shared computing facility or cloud computing facility.

### 2.2. Application Program Overview

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for inventions and disclosures of this type.

In an embodiment, user 102 interacts with agricultural intelligence computer system 130 using field manager computing device 104 configured with an operating system and one or more application programs or apps; the field manager computing device 104 also may interoperate with the agricultural intelligence computer system independently and automatically under program control or logical control and direct user interaction is not always required. Field manager computing device 104 broadly represents one or more of a smart phone, PDA, tablet computing device, laptop computer, desktop computer, workstation, or any other computing device capable of transmitting and receiving information and performing the functions described herein. Field manager computing device 104 may communicate via a network using a mobile application stored on field manager computing device 104, and in some embodiments, the device may be coupled using a cable 113 or connector to the sensor 112 and/or controller 114. A particular user 102 may own, operate or possess and use, in connection with system 130, more than one field manager computing device 104 at a time.

The mobile application may provide client-side functionality, via the network to one or more mobile computing devices. In an example embodiment, field manager computing device 104 may access the mobile application via a web browser or a local client application or app. Field manager computing device 104 may transmit data to, and receive data from, one or more front-end servers, using web-based protocols or formats such as HTTP, XML, and/or JSON, or app-specific protocols. In an example embodiment, the data may take the form of requests and user information input, such as field data, into the mobile computing device. In some embodiments, the mobile application interacts with location tracking hardware and software on field manager computing device 104 which determines the location of field manager computing device 104 using standard tracking techniques such as multilateration of radio signals, the global positioning system (GPS), WiFi positioning systems, or other methods of mobile positioning. In some cases, location data or other data associated with the device 104, user 102, and/or user account(s) may be obtained by queries to an operating system of the device or by requesting an app on the device to obtain data from the operating system.

In an embodiment, field manager computing device 104 sends field data 106 to agricultural intelligence computer system 130 comprising or including, but not limited to, data values representing one or more of: a geographical location of the one or more fields, tillage information for the one or more fields, crops planted in the one or more fields, and soil data extracted from the one or more fields. Field manager computing device 104 may send field data 106 in response to user input from user 102 specifying the data values for the one or more fields. Additionally, field manager computing device 104 may automatically send field data 106 when one or more of the data values becomes available to field manager computing device 104. For example, field manager computing device 104 may be communicatively coupled to remote sensor 112 and/or application controller 114 which include an irrigation sensor and/or irrigation controller. In response to receiving data indicating that application controller 114 released water onto the one or more fields, field manager computing device 104 may send field data 106 to agricultural intelligence computer system 130 indicating that water was released on the one or more fields. Field data 106 identified in this disclosure may be input and communicated using electronic digital data that is communicated between computing devices using parameterized URLs over HTTP, or another suitable communication or messaging protocol.

A commercial example of the mobile application is CLIMATE FIELDVIEW, commercially available from The Climate Corporation, San Francisco, Calif. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

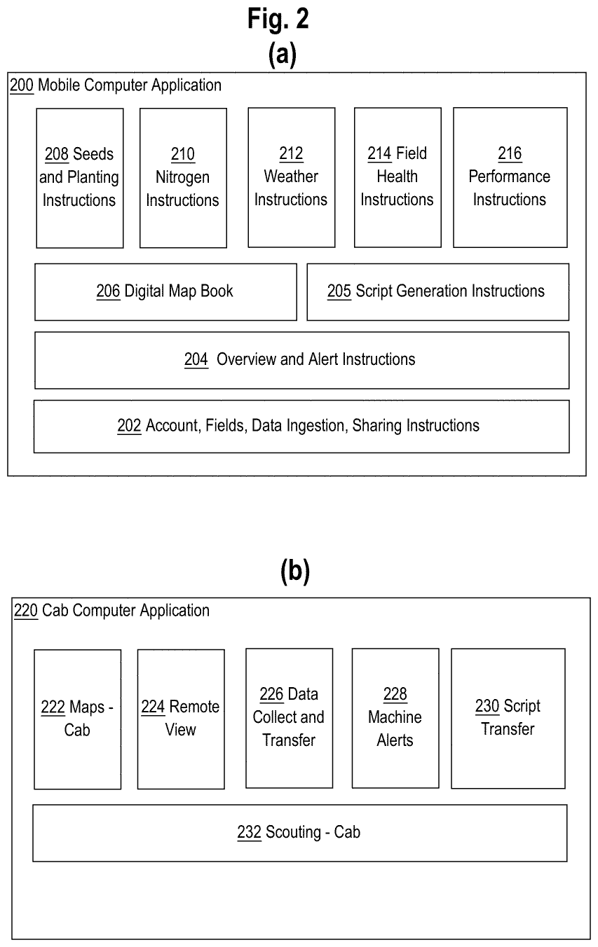

FIG. 2 illustrates two views of an example logical organization of sets of instructions in main memory when an example mobile application is loaded for execution. In FIG. 2, each named element represents a region of one or more pages of RAM or other main memory, or one or more blocks of disk storage or other non-volatile storage, and the programmed instructions within those regions. In one embodiment, in view (a), a mobile computer application 200 comprises account-fields-data ingestion-sharing instructions 202, overview and alert instructions 204, digital map book instructions 206, seeds and planting instructions 208, nitrogen instructions 210, weather instructions 212, field health instructions 214, and performance instructions 216.

In one embodiment, a mobile computer application 200 comprises account, fields, data ingestion, sharing instructions 202 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 200 comprises a data inbox. In response to receiving a selection of the data inbox, the mobile computer application 200 may display a graphical user interface for manually uploading data files and importing uploaded files to a data manager.

In one embodiment, digital map book instructions 206 comprise field map data layers stored in device memory and are programmed with data visualization tools and geospatial field notes. This provides growers with convenient information close at hand for reference, logging and visual insights into field performance. In one embodiment, overview and alert instructions 204 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 208 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 205 are programmed to provide an interface for generating scripts, including variable rate (VR) fertility scripts. The interface enables growers to create scripts for field implements, such as nutrient applications, planting, and irrigation. For example, a planting script interface may comprise tools for identifying a type of seed for planting. Upon receiving a selection of the seed type, mobile computer application 200 may display one or more fields broken into management zones, such as the field map data layers created as part of digital map book instructions 206. In one embodiment, the management zones comprise soil zones along with a panel identifying each soil zone and a soil name, texture, drainage for each zone, or other field data. Mobile computer application 200 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 200 may make the script available for download in a format readable by an application controller, such as an archived or compressed format. Additionally, and/or alternatively, a script may be sent directly to cab computer 115 from mobile computer application 200 and/or uploaded to one or more data servers and stored for further use.

In one embodiment, nitrogen instructions 210 are programmed to provide tools to inform nitrogen decisions by visualizing the availability of nitrogen to crops. This enables growers to maximize yield or return on investment through optimized nitrogen application during the season. Example programmed functions include displaying images such as SSURGO images to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields and/or zones that have been defined in the system; example data may include nitrogen application data that is the same for many fields and/or zones of the same grower, but such mass data entry applies to the entry of any type of field data into the mobile computer application 200. For example, nitrogen instructions 210 may be programmed to accept definitions of nitrogen application and practices programs and to accept user input specifying to apply those programs across multiple fields. “Nitrogen application programs,” in this context, refers to stored, named sets of data that associates: a name, color code or other identifier, one or more dates of application, types of material or product for each of the dates and amounts, method of application or incorporation such as injected or broadcast, and/or amounts or rates of application for each of the dates, crop or hybrid that is the subject of the application, among others. “Nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Nitrogen instructions 210 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 210 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 210 could be used for application of other nutrients (such as phosphorus and potassium), application of pesticide, and irrigation programs.

In one embodiment, weather instructions 212 are programmed to provide field-specific recent weather data and forecasted weather information. This enables growers to save time and have an efficient integrated display with respect to daily operational decisions.

In one embodiment, field health instructions 214 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 216 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 216 may be programmed to communicate via the network(s) 109 to back-end analytics programs executed at agricultural intelligence computer system 130 and/or external data server computer 108 and configured to analyze metrics such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of cab computer 115. For example, referring now to view (b) of FIG. 2, in one embodiment a cab computer application 220 may comprise maps-cab instructions 222, remote view instructions 224, data collect and transfer instructions 226, machine alerts instructions 228, script transfer instructions 230, and scouting-cab instructions 232. The code base for the instructions of view (b) may be the same as for view (a) and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 222 may be programmed to provide map views of fields, farms or regions that are useful in directing machine operation. The remote view instructions 224 may be programmed to turn on, manage, and provide views of machine activity in real-time or near real-time to other computing devices connected to the system 130 via wireless networks, wired connectors or adapters, and the like. The data collect and transfer instructions 226 may be programmed to turn on, manage, and provide transfer of data collected at sensors and controllers to the system 130 via wireless networks, wired connectors or adapters, and the like. The machine alerts instructions 228 may be programmed to detect issues with operations of the machine or tools that are associated with the cab and generate operator alerts. The script transfer instructions 230 may be configured to transfer in scripts of instructions that are configured to direct machine operations or the collection of data. The scouting-cab instructions 232 may be programmed to display location-based alerts and information received from the system 130 based on the location of the field manager computing device 104, agricultural apparatus 111, or sensors 112 in the field and ingest, manage, and provide transfer of location-based scouting observations to the system 130 based on the location of the agricultural apparatus 111 or sensors 112 in the field.

### 2.3. Data Ingest to the Computer System

In an embodiment, external data server computer 108 stores external data 110, including soil data representing soil composition for the one or more fields and weather data representing temperature and precipitation on the one or more fields. The weather data may include past and present weather data as well as forecasts for future weather data. In an embodiment, external data server computer 108 comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil.

In an embodiment, remote sensor 112 comprises one or more sensors that are programmed or configured to produce one or more observations. Remote sensor 112 may be aerial sensors, such as satellites, vehicle sensors, planting equipment sensors, tillage sensors, fertilizer or insecticide application sensors, harvester sensors, and any other implement capable of receiving data from the one or more fields. In an embodiment, application controller 114 is programmed or configured to receive instructions from agricultural intelligence computer system 130. Application controller 114 may also be programmed or configured to control an operating parameter of an agricultural vehicle or implement. For example, an application controller may be programmed or configured to control an operating parameter of a vehicle, such as a tractor, planting equipment, tillage equipment, fertilizer or insecticide equipment, harvester equipment, or other farm implements such as a water valve. Other embodiments may use any combination of sensors and controllers, of which the following are merely selected examples.

The system 130 may obtain or ingest data under user 102 control, on a mass basis from a large number of growers who have contributed data to a shared database system. This form of obtaining data may be termed “manual data ingest” as one or more user-controlled computer operations are requested or triggered to obtain data for use by the system 130. As an example, the CLIMATE FIELDVIEW application, commercially available from The Climate Corporation, San Francisco, Calif., may be operated to export data to system 130 for storing in the repository 160.

For example, seed monitor systems can both control planter apparatus components and obtain planting data, including signals from seed sensors via a signal harness that comprises a CAN backbone and point-to-point connections for registration and/or diagnostics. Seed monitor systems can be programmed or configured to display seed spacing, population and other information to the user via the cab computer 115 or other devices within the system 130. Examples are disclosed in U.S. Pat. No. 8,738,243 and US Pat. Pub. 20150094916, and the present disclosure assumes knowledge of those other patent disclosures.

Likewise, yield monitor systems may contain yield sensors for harvester apparatus that send yield measurement data to the cab computer 115 or other devices within the system 130. Yield monitor systems may utilize one or more remote sensors 112 to obtain grain moisture measurements in a combine or other harvester and transmit these measurements to the user via the cab computer 115 or other devices within the system 130.

In an embodiment, examples of sensors 112 that may be used with any moving vehicle or apparatus of the type described elsewhere herein include kinematic sensors and position sensors. Kinematic sensors may comprise any of speed sensors such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors 112 that may be used with tractors or other moving vehicles include engine speed sensors, fuel consumption sensors, area counters or distance counters that interact with GPS or radar signals, PTO (power take-off) speed sensors, tractor hydraulics sensors configured to detect hydraulics parameters such as pressure or flow, and/or and hydraulic pump speed, wheel speed sensors or wheel slippage sensors. In an embodiment, examples of controllers 114 that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors 112 that may be used with seed planting equipment such as planters, drills, or air seeders include seed sensors, which may be optical, electromagnetic, or impact sensors; downforce sensors such as load pins, load cells, pressure sensors; soil property sensors such as reflectivity sensors, moisture sensors, electrical conductivity sensors, optical residue sensors, or temperature sensors; component operating criteria sensors such as planting depth sensors, downforce cylinder pressure sensors, seed disc speed sensors, seed drive motor encoders, seed conveyor system speed sensors, or vacuum level sensors; or pesticide application sensors such as optical or other electromagnetic sensors, or impact sensors. In an embodiment, examples of controllers 114 that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors 112 that may be used with tillage equipment include position sensors for tools such as shanks or discs; tool position sensors for such tools that are configured to detect depth, gang angle, or lateral spacing; downforce sensors; or draft force sensors. In an embodiment, examples of controllers 114 that may be used with tillage equipment include downforce controllers or tool position controllers, such as controllers configured to control tool depth, gang angle, or lateral spacing.

In an embodiment, examples of sensors 112 that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors such as accelerometers disposed on sprayer booms. In an embodiment, examples of controllers 114 that may be used with such apparatus include pump speed controllers; valve controllers that are programmed to control pressure, flow, direction, PWM and the like; or position actuators, such as for boom height, subsoiler depth, or boom position.

In an embodiment, examples of sensors 112 that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers 114 that may be used with harvesters include header operating criteria controllers for elements such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors 112 that may be used with grain carts include weight sensors, or sensors for auger position, operation, or speed. In an embodiment, examples of controllers 114 that may be used with grain carts include controllers for auger position, operation, or speed.

In an embodiment, examples of sensors 112 and controllers 114 may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosure.

In an embodiment, sensors 112 and controllers 114 may be affixed to soil sampling and measurement apparatus that is configured or programmed to sample soil and perform soil chemistry tests, soil moisture tests, and other tests pertaining to soil. For example, the apparatus disclosed in U.S. Pat. No. 8,767,194 and U.S. Pat. No. 8,712,148 may be used, and the present disclosure assumes knowledge of those patent disclosures.

In an embodiment, sensors 112 and controllers 114 may comprise weather devices for monitoring weather conditions of fields. For example, the apparatus disclosed in U.S. Provisional Application No. 62/154,207, filed on Apr. 29, 2015, U.S. Provisional Application No. 62/175,160, filed on Jun. 12, 2015, U.S. Provisional Application No. 62/198,060, filed on Jul. 28, 2015, and U.S. Provisional Application No. 62/220,852, filed on Sep. 18, 2015, may be used, and the present disclosure assumes knowledge of those patent disclosures.

### 2.4. Process Overview-Agronomic Model Training

In an embodiment, the agricultural intelligence computer system 130 is programmed or configured to create an agronomic model. In this context, an agronomic model is a data structure in memory of the agricultural intelligence computer system 130 that comprises field data 106, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples the revenue or profit obtained from the produced crop.

In an embodiment, the agricultural intelligence computer system 130 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

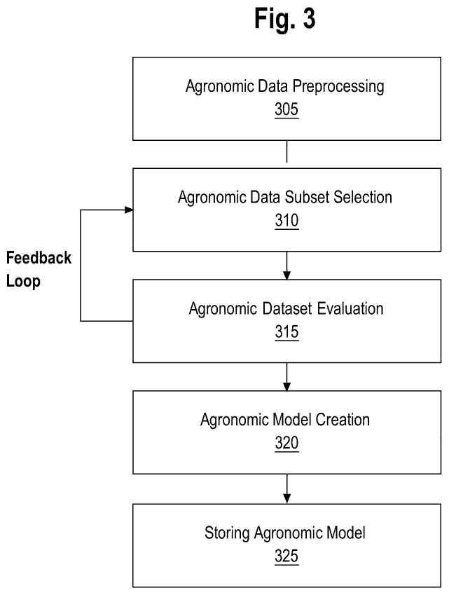

FIG. 3 illustrates a programmed process by which the agricultural intelligence computer system generates one or more preconfigured agronomic models using field data provided by one or more data sources. FIG. 3 may serve as an algorithm or instructions for programming the functional elements of the agricultural intelligence computer system 130 to perform the operations that are now described.

At block 305, the agricultural intelligence computer system 130 is configured or programmed to implement agronomic data preprocessing of field data received from one or more data sources. The field data received from one or more data sources may be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs.

At block 310, the agricultural intelligence computer system 130 is configured or programmed to perform data subset selection using the preprocessed field data in order to identify datasets useful for initial agronomic model generation. The agricultural intelligence computer system 130 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 315, the agricultural intelligence computer system 130 is configured or programmed to implement field dataset evaluation. In an embodiment, a specific field dataset is evaluated by creating an agronomic model and using specific quality thresholds for the created agronomic model. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 310).

At block 320, the agricultural intelligence computer system 130 is configured or programmed to implement agronomic model creation based upon the cross validated agronomic datasets. In an embodiment, agronomic model creation may implement multivariate regression techniques to create preconfigured agronomic data models.

At block 325, the agricultural intelligence computer system 130 is configured or programmed to store the preconfigured agronomic data models for future field data evaluation.

### 2.5. Implementation Example-Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infrared data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 3. Trial Generation

Methods are described herein for generating data for implementing a trial. As used herein, a trial refers to performing one or more different agricultural activities in a portion of an agricultural field in order to identify a benefit or detriment of performing the one or more different agricultural activities. As an example, a subfield area may be selected in an agricultural field to implement a fungicide trial. Within the subfield area, the crops may receive an application of fungicide while the rest of the field and/or a different subfield area on the field does not receive an application of fungicide. Alternatively, the rest of the field may receive the application of fungicide while the crops within the subfield area do not. The subfield areas of the field where the one or more different agricultural activities are performed are referred to herein as test locations. In some embodiments, subfield areas that do not include the different agricultural activities can also be assigned and referred to as test locations.

Trials may be performed for testing the efficacy of new products, different management practices, different crops, or any combination thereof. For example, if a field usually does not receive fungicide, a trial may be designed wherein crops within a selected portion of the field receive fungicide at one or more times during the development of the crop. As another example, if a field usually is conventionally tilled, a trial may be designed wherein a selected portion of the field is not tilled. Thus, trials may be implemented for determining whether to follow management practice recommendations instead of being constrained to testing the efficacy of a particular product. Additionally or alternatively, trials may be designed to compare two different types of products, planting rates, equipment, and/or other management practices.

Trials may be constrained by one or more rules. A trial may require one or more testing locations to be of a particular size and/or placed in a particular location. For example, the trial may require one or more testing locations to be placed in an area of the field with comparable conditions to the rest of the field. A testing location, as used herein, refers to an area of an agricultural field that receives one or more different treatments from surrounding areas. Thus, a testing location may refer to any shape of land on an agricultural field. Additionally or alternatively, the trial may require one or more testing locations to be placed in an area of the field with conditions differing from the rest of the field and/or areas of the field spanning different types of conditions. The trial may require one or more different management practices to be undertaken in one or more testing locations. For example, a trial may require a particular seeding rate as part of a test for planting a different type of hybrid seed.

In an embodiment, the methods described herein are used to cause implementation of the trial. For example, the methods described herein may be used to identify, size, and orient testing locations for efficient implementation of the trial, such as by maximizing efficiency in area usage, minimizing a number of required passes of agricultural implements, or maximizing available area in an agricultural field for implementing the trial. The methods described herein may further be used to generate agricultural scripts which comprise computer readable instructions which, when executed, cause an agricultural implement to perform an action on the field according to the trial.

### 3.1. Short Length Field Variability

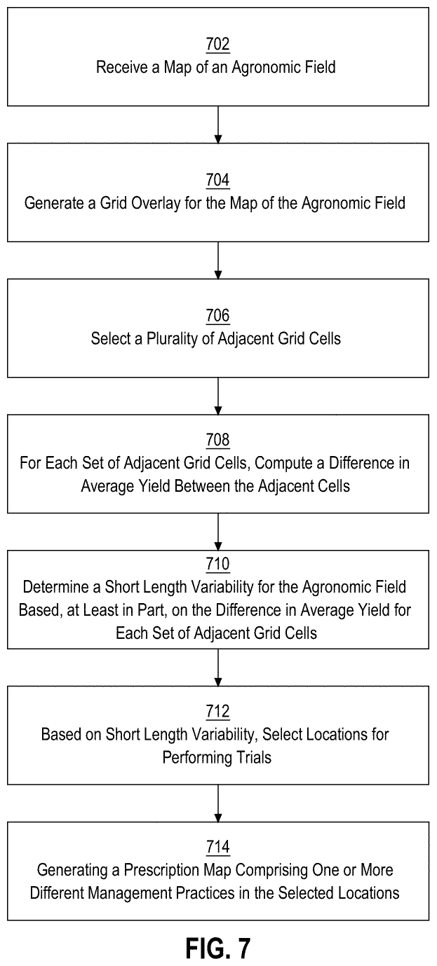

In an embodiment, the agricultural intelligence computer system computes a short length field variability for purposes of performing a trial on an agricultural field. The short length field variability indicates the extent to which a field varies across small distances. FIG. 7 depicts a method for modeling short length variability within a field.

At step 702, a map of an agricultural field is received. For example, the agricultural intelligence computer system may receive aerial imagery of an agricultural field. Additionally or alternatively, the agricultural intelligence computer system may receive input delineating boundaries of an agricultural field, such as through a map displayed on a client computing device and/or input specifying latitude and longitude of field boundaries. The map may also be generated from one or more agricultural implements on the agricultural field. For example, a planter may generate as-applied data indicating a seeding type and/or seeding population along with geographic coordinates that correspond to the seeding type and/or seeding population. The planter may send the as-applied data to the agricultural intelligence computer system.

In an embodiment, the system additionally receives agricultural yield data for the agricultural field. For example, an agricultural implement, such as a harvester, may generate data indicating a yield of a portion of the agricultural field and send the yield data to the agricultural intelligence computer system. The agricultural intelligence computer system may generate a yield map indicating, for each location on the agricultural field, an agricultural yield.

At step 704, a grid overlay is generated for the map of the agricultural field. For example, the agricultural intelligence computer system may generate a grid with a plurality of cells to overlay on the map of the agricultural field. Generating the grid may comprise identifying a field boundary, determining a width and length for the grid cells, generating a first set of parallel lines separated by a distance equal to the width of the grid cells and generating a second set of parallel lines that are perpendicular to the first set of parallel lines and are separated by a distance equal to the width of the grid cells. The width of the grid cells may be determined based on the width of a head of a combine, the width of application equipment, the width of management equipment, or the width of a planter for the agricultural field. For example, a multiple of an equipment width can be used. Specifically, if the combine head is 30 ft wide, the width of the grid cells may be a multiple, 30 ft, 60 ft, 90 ft, 120 ft, and so on.

For another example, a common multiple can be used. Specifically, if the combine is 20 ft wide and the planter is 40 ft wide and the different management practices are planting related, like two seeding population densities, the width of the grid cells maybe a common multiple of both widths, 40 ft, 80 ft, 120 ft, and so on. The width of the grid cells may also be increased to allow for getting yield data from each treatment even if the combine is misaligned with the other management equipment. For example, if the combine is 20 ft wide and the fungicide application equipment is 30 ft wide and the different management practices are applying fungicide or not, the width of the grid cells may be 60 ft, 90 ft, 120 ft, and so on, with the combine able to harvest one or more passes entirely within each treatment even if the combine is not aligned with the fungicide application equipment. The width of the grid cells may also include a buffer to allow for local mixing between management practices. For example if the combine is 20 ft wide and the fungicide application equipment is 60 ft wide and the different management practices are applying fungicide or not, the width of the grid cells may be 60 ft, 90 ft, 120 ft, and so on, with the combine able to harvest one or more passes entirely within one treatment even if 20 ft on each side of each treatment boundary is thrown out as a buffer area to allow for any drift in the fungicide. The length of the grid cells may be determined using the methods described herein. As an example, each grid cell may be 120 ft×300 ft.

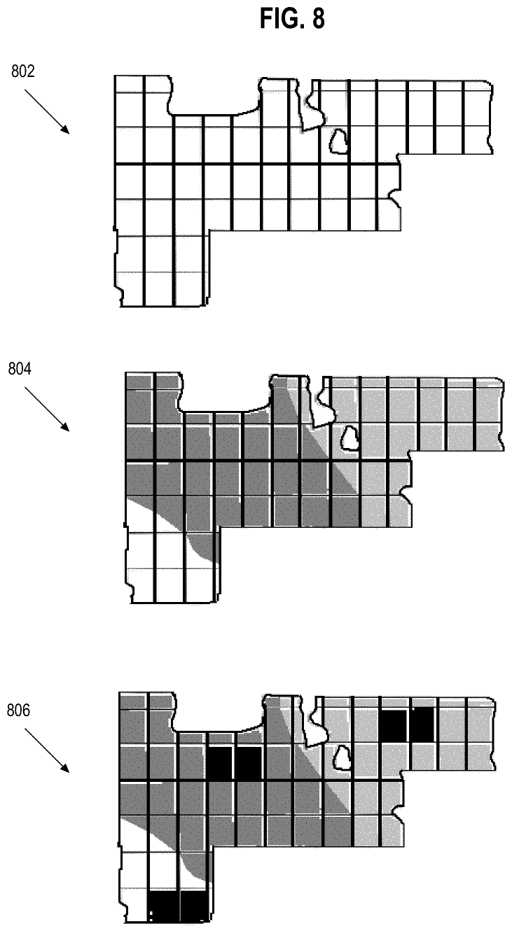

FIG. 8 depicts an example of a grid overlay on a map used for computing short length yield variability. Map 802 comprises a grid overlaying a map of an agricultural field. As shown in map 802, the first vertical line is generated at a grid cell width away from the leftmost boundary of the map whereas the first horizontal line is generated at a grid cell length away from the bottommost boundary of the map. In an embodiment, the agricultural field additionally includes management zones. For example, map 804 depicts a grid overlay on a map of an agricultural field which contains three management zones that are differentiated by color. The management zones refer to sections of the agricultural field which receive similar management treatment or have previously been grouped based on shared characteristics.

Referring again to FIG. 7, at step 706, a plurality of adjacent grid cells is selected. For example, the agricultural intelligence computer system may randomly or pseudo-randomly select, from the grid cells of the grid overlay, a first grid cell. The agricultural intelligence computer system may then randomly or pseudo-random select, from adjacent grid cells of the first grid cell, a second grid cell. Additionally or alternatively, the agricultural intelligence computer system may utilize a specific rule for selecting the adjacent cell, such as initially attempting to select a cell from the right of the first cell followed by the cell to the left of the first cell and so on. If there are no adjacent grid cells to the first grid cell, the agricultural intelligence computer system may discard the selected first grid cell and randomly or pseudo-randomly select a different grid cell. Additionally, the agricultural intelligence computer system may randomly or pseudo-randomly select sets of adjacent cells, one for each different management practice.

In an embodiment, the agricultural intelligence computer system identifies complete grid cells from which to select the first grid cell and/or the second grid cell. For example, map 802 in FIG. 8 includes incomplete grid cells, such as the cells abutting the boundary of the agricultural field. The agricultural intelligence computer system may remove the incomplete grid cells and select the first grid cell and second grid cell from the remaining grid cells. For the purpose of selection, the agricultural intelligence computer system may treat the incomplete grid cells as non-existent.

In an embodiment, the agricultural intelligence computer system also identifies grid cells that are completely in a single management zone from which to select the first grid cell and/or the second grid cell. For example, map 804 includes grid cells that comprise multiple management zones due to the border for the management zones running through the grid cell. The agricultural intelligence computer system may remove grid cells that comprise multiple management zones and select the first grid cell and second grid cell from the remaining grid cells. For the purpose of selection, the agricultural intelligence computer system may treat the grid cells comprising multiple management zones as non-existent.

In an embodiment, adjacent cells are selected to be in the same management zone. Map 806 in FIG. 8 depicts a selection of a plurality of sets of adjacent cells. Each set of adjacent cells in map 806 comprises two cells in the same management zone, even though the sets of adjacent cells span management zones.

At step 708, for each set of adjacent grid cells, a difference in average yield between the adjacent cells is computed. For example, the agricultural intelligence computer system may store data identifying the average yield for each grid. The data identifying the average yield may be based on harvesting data indicating yield for a portion of the agricultural field covered by the cell and/or modeled based on received data or imagery. The agricultural intelligence computer system may compute an absolute value of the difference between adjacent cells in each set. Thus, if one cell has an average yield of 170.8 bushels per acre and the adjacent cell has an average yield of 171.2 bushels per acre, the system may compute the difference in average yield between the adjacent cells as 0.4 bushels per acre.

At step 710, a short length variability for the agricultural field is determined based, at least in part, on the difference in average yield for each set of adjacent cells. For example, the agricultural intelligence computer system may identify a median of the differences across the plurality of sets of adjacent cells and select the median value as the short length variability for the agricultural field.

At step 712, based on the short length variability, one or more locations are selected for performing trials. Methods for selecting fields and/or locations on fields for performing trials are described further herein.

At step 714, the system generates a prescription map comprising one or more different management practices in the selected locations. For example, the system may begin implementation of the trial by generating a prescription map where the selected locations include a different planting population, nutrient application, chemical application, irrigation, and/or other management practice that is different than one or more surrounding locations. Methods of generating a prescription map are described in Section 3.7.

### 3.2. Modeling Variability

In an embodiment, short length variability is modeled based on a plurality of factors. For example, the system may model the average yield for each cell as a function of one or more of elevation, organic matter, nutrient levels, soil type or property, and/or other field level variables. Additionally or alternatively, the system may model the variability between adjacent cells as a function of a plurality of factors. Each function, equation and calculation described in this section may be programmed as part of the instructions that have been described for FIG. 1 to receive data values for the specified parameters and to calculate by computer the transformations that are shown mathematically to yield the results that are described.

As an example, the system may model short length variability according to the following function:

$$V = {\sum }_{i = 1}^{n} \frac{{w}_{A} ( {A}_{i , a} - {A}_{i , b} ) + {w}_{B} ( {B}_{i , a} - {B}_{i , b} ) + … {w}_{N} ( {N}_{i , a} - {N}_{i , b} )}{n}$$

where N_{i,a}-N_{i,b} is the difference in the Nth attribute between cell a and cell b of the i-th set of adjacent pairs and w_{N} is a weight for the Nth attribute. For example, if the short length variability was modeled based on elevation, pH value, and organic matter, the short length variability equation would take the form of:

$$V = {\sum }_{i = 1}^{n} \frac{{w}_{E} ( {E}_{i , a} - {E}_{i , b} ) + {w}_{p H} ( p {H}_{i , a} - p {H}_{i , b} ) + {w}_{O} ( {O}_{i , a} - {O}_{i , b} )}{n}$$

where E is the average elevation, pH is the average pH value, and O is the average organic matter for each grid cell.

While the above equation computes short length variability for the field as an average of variabilities at individual locations, in an embodiment difference value is computed for each location according to:

Dᵢ=w_{A}(A_{i,a}−A_{i,b})+w_{B}(B_{i,a}−B_{i,b})+ . . . w_{N} (N_{i,a}−N_{i,b})

and the short length variability is determined as the median difference value amongst the plurality of locations.

In an embodiment, the weights for the above equations are empirically chosen. Additionally or alternatively, the agricultural intelligence computer system may compute the weights based on yield variation data from other fields. For example, agricultural intelligence computer system may receive, for a plurality of pair of adjacent locations, data identifying the yield for each location of the pair and data identifying a plurality of attribute values for each location and pair. The system may then compute weights for the above equation by selecting weights that minimize the following equation:

$${\sum }_{i}^{n} {Y}_{i , a} - {Y}_{i , b} - ( {w}_{A} ( {A}_{i , a} - {A}_{i , b} ) + {w}_{B} ( {B}_{i , a} - {B}_{i , b} ) + … {w}_{N} ( {N}_{i , a} - {N}_{i , b} ) )$$

where Y_{i,a}−Y_{i,b} is the difference between average yields for the i-th set of adjacent pairs a and b. The system may use any known minimization technique to compute the weights w_{A}-w_{N} that minimize the above equation. The short length variability equation may then be used to identify short length variability where prior yield data is unavailable, but soil data is available for each cell.

In an embodiment, the system models short length variability as a function of pixel values in satellite images of the field. For example, the system may receive satellite images of the agricultural field. Using the satellite images, the system may compute a value, such as an average normalized difference vegetation index (NDVI) value, for each grid cell. The system may then determine short length variability as the median of the differences between NDVI values between adjacent cells of a plurality of sets of adjacent cells. Additionally or alternatively, pixel values and/or values computed based on pixels values may be used as an additional parameter in the above described modeling equations.

### 3.3. Selecting Fields Based on Short Length Variability

In an embodiment, the agricultural intelligence computer selects fields for performing trials based on computed short length variability. For example, the agricultural intelligence computer system may receive a request to generate prescription maps for a plurality of agricultural fields that implement one or more trials. The agricultural intelligence computer system may use the methods described herein to compute the short length variability for each agricultural field. The agricultural intelligence computer system may then select an agricultural field for performing a trial based on the short length variability. For instance, the agricultural intelligence computer system may select the agricultural field with the lowest short length variability of the plurality of agricultural fields.

In an embodiment, the agricultural intelligence computer system additionally computes a long length variability value. For example, for each of a plurality of grid cells, the agricultural intelligence computer system may compute a difference between the average yield for the grid cell and an average yield of the agricultural field containing the grid cell. Additionally or alternatively, the agriculture intelligence computer system may model the long length variability as a function of field values or image pixel values using any of the methods described in Section 3.2, but replacing the plurality of pairs of adjacent grid cells with a plurality of pairs comprising a grid cell and averages for the agricultural field.

The system may select agricultural fields with a low short length variability score and a high long length variability score for performing the trial. For example, the system may identify a plurality of fields where the short length variability score is below a threshold value and select from the identified plurality of fields the agricultural field with the highest long length variability score. Additionally or alternatively, the system may identify a plurality of fields where the long length variability score is below a threshold value and the select from the identified plurality of fields the agricultural field with the lowest short length variability value. As another example, the system may select the agricultural field with the highest variability difference value, where the variability difference value is computed as:

V_{D}=αV_{L}−βV_{S}

where V_{d} is the variability difference value, V_{L} is the long length variability value, V_{S} is the short length variability value, and α and β are weights selected based on whether it is more important for the trial for long length variability to be high or for short length variability to be low.

### 3.4. Selecting and Sizing Testing Locations

In an embodiment, the system uses differences between adjacent locations to select one or more pairs as testing locations for performing one or more trials. For example, the system may compute a difference in average yield for a plurality of pairs of adjacent grid cells or model a difference value between pairs of adjacent grid cells using any of the methods described herein. The system may then select N pairs of sets of adjacent grid cells with the lowest computed or modeled differences for performing a trial on the agricultural field.

The number N of trials may be predetermined and/or computed. For example, the agricultural intelligence computer system may receive a request to generate a prescription map with a particular number of trials. The agricultural intelligence computer system may then use the methods described herein to identify one or more fields and/or testing locations for performing the trials. As another example, the agricultural intelligence computer system may compute the number of testing locations as:

$$N = {( \frac{SNR * σ}{T} )}^{2}$$

where SNR is the signal-to-noise ration defined by a ratio between the average yield for each location and the short length yield variation, a is the standard deviation of the average yield difference between potential testing locations, and T is the expected detectable treatment effect. Thus, if an experiment is expected to raise yield by 5 bushels per acre, T would be 5.

In an embodiment, the system determines an area for performing the trials in a manner that increases statistical significance of the trial while reducing the amount of area required to perform the trials. For example, the system may compute a trial size as:

A_{T}=2wb

where w is the width and b is a buffer size for the trial type. The buffer size refers to a spatial distance required for an agricultural implement to shift from one treatment type to the next. For example, the buffer size for a planter may be 3 ft to indicate that it takes the planter 3 ft to switch from one seeding population to a different seeding population while the buffer size for nutrient application may be 50 ft to indicate that it takes the implement 50 ft to switch from one application amount of a nutrient to a second application amount.

In an embodiment, the above equation is also used to compute a grid overlay size. For example, a first grid overlay may be used to determine short length variability for a field. The system may then use the above equation to determine an optimal size for testing locations using the above equation. The system may then generate a new grid overlay based on the computed trial size. In an embodiment, the system pre-selects a width of the grid cells based on a width of one or more agricultural implements and uses the pre-selected width and area to compute the length of each grid cell.

### 3.5. Determining Testing Location Orientation

In an embodiment, the agriculture intelligence computer system determines an orientation of the grid overlay and/or testing locations based on header information of one or more agricultural implements on the agricultural field. For example, an agricultural implement may continually capture data identifying a direction of movement of the agricultural implement during one or more agricultural activities, such as planting of a field, and send the captured data to the agricultural intelligence computer system. The received directional data may include directional data related to turns at the ends of passes and directional data when the planter is moving both up and down the field.

In order to remove errors caused by the planter moving both up and down the field, the system may identify directional data within a 180° arc and set each direction within the 180° arc to be the reverse of that direction. Thus, if 45% of the direction values for a planter indicate that the planter is moving North and 45% of the direction values for the planter indicate the planter is moving South, the agricultural intelligence computer system may flip the South values so that 90% of the direction values for the planter indicate the planter is moving North. In order to remove directional data relating to turns at the end of passes, the agricultural intelligence computer system may select the median direction of the directional data, thereby removing the numerical outliers caused by turning of the agricultural equipment and movement around trees and other obstacles.

In an embodiment, the agricultural intelligence computer system identifies locations where the planter has changed headings. For example, for a first portion of the field, the planter may plant at a first angle and, for a second portion of the field, the planter may plant at a second angle. In order to identify locations where the planter has begun planting in a different direction, the agricultural intelligence computer system may utilize a grouping algorithm to identify locations where the values indicating direction of the planter has changed.

In an embodiment, the agricultural intelligence computer system determines that a change of direction has occurred when greater than a threshold number of sequential directional values identify a same direction that is greater than a threshold number of degrees different than a previous direction. For example, if the planter generates a new directional value every 5 seconds, the system may determine that the planter has begun planting in a new direction if more than 20 sequential directional values are greater than 5° different from a prior determined direction.

In an embodiment, the agricultural intelligence computer system uses imagery to determine a direction of the planter. For example, the agricultural intelligence computer system may identify straight lines in an aerial image of the agricultural field, such as on the boundaries of the agricultural field. The agricultural intelligence computer system may determine that the straight lines in the imagery correspond to a direction of the planting of the agricultural field and set the grid to line up with the identified direction.

3.6. Selecting from Grid Locations

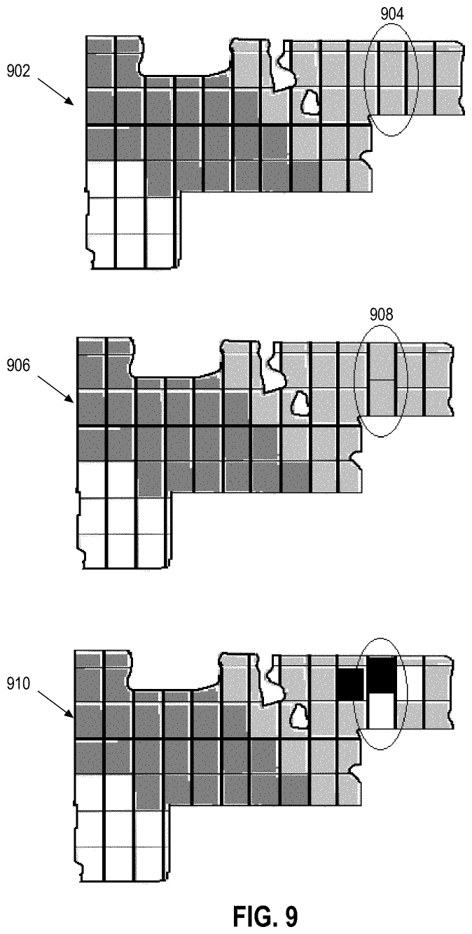

In an embodiment, the agricultural intelligence computer system varies the locations of cells within a grid to maximize a number of testing locations that can be planted in an agricultural field. FIG. 9 depicts an example method of varying testing locations within a preset grid to maximize a number of testing locations.

Map 902 depicts a first map of a field with a grid overlay. In the examples of FIG. 9, the vertical lines of the grid are fixed as corresponding to a directional movement of the planter. Area 904 depicts a location with map 902 which includes one complete grid cell and two incomplete grid cells. In an embodiment, the agricultural intelligence computer system identifies locations that include incomplete grid cells. The agricultural intelligence computer system may shift cells in the identified location in a single direction, such as the direction of the planter, to fit more complete cells. For example, in map 906, the cells in location 908 have been shifted up. Whereas in map 902, only one complete cell fits in the location, in map 906 two cells were able to fit in the same location 908. Thus, in map 910, both cells are capable of being used in different trials.

In an embodiment, agricultural intelligence computer system identifies one or more incomplete cells in the grid. Agricultural intelligence computer system then determines which half of the cell comprises the largest contiguous complete area from the boundary. For example, if a corner is missing from the top of the cell, but the bottom of the cell is intact, the system may identify the bottom portion of the cell as the most complete. The agricultural intelligence computer system may then shift the cell and all cells affected by the shift in the direction of the most intact portion of the cell until a complete cell is made. The agricultural intelligence computer system may then determine whether the column containing the cell has a greater number of complete cells than before. If the column contains a greater number of cells, the system may continue the process with the next incomplete cell in the column. If not, the system may revert the column to its pre-shifted state and continue the process with the next incomplete cell in the column. Once the process has been performed with each incomplete cell in the column, the system may continue the process with the next column.

While the above methods are described in terms of field boundary, they may also be utilized with respect to management zones. For example, a cell may be considered incomplete if it comprises more than one management zone. Thus, the system may shift cells up or down in order to maximize a number of complete cells in a management zone. In an embodiment, the system first selects a smallest management zone and performs the method described herein to increase a number of cells in the smallest management zone. The system may then perform the method in the next smallest management zone. After shifting cells in a management zone, the system may additionally determine if the shift reduced a number of complete cells in a previous management zone. If so, the system reverts the column to its pre-shifted state and continues the process with the next incomplete cell in the column.

In an embodiment, the system is able to shift cells such that two sequential cells are not abutting. For example, when a first cell is shifted down, the cell above the first cell may not be shifted. Thus, the system is able to shift cells around obstacles in the middle of fields, such as small bodies of water and large trees while maximizing the number of cells in the grid overlay.

While embodiments have been described using two adjacent cells, some trials require use of more than two locations. For such locations, the system may identify clusters within a management zone for performing the trial. The system may first select the smallest management zone, thereby maximizing the number of trials done in the smaller zones. The system may then randomly or pseudo-randomly select a first location. The system may then pseudo-randomly select second locations touching the first location until all of the locations have been placed or no more surrounding locations are available. If more locations need to be placed, the system may randomly or pseudo-randomly select third locations touching the second locations. The system may continue the process until all locations have been placed or no more locations can be placed. If no more locations can be placed, the system may remove all prior placed locations and randomly or pseudo-randomly place the a new first location in the management zone to continue the process. If more than a threshold number of attempts to place a cluster of location have ended in failure, the system may then move to the next management zone.

### 3.7. Prescription Maps and Scripts

The methods described herein improve the process of the computer's generation of prescription maps for performing one or more agricultural tasks on an agricultural field. For example, the agricultural intelligence computer system may receive a request to generate a prescription map for an agricultural field with one or more specific trials. The agricultural intelligence computer system may use the methods described above to identify fields and testing locations, orientations of the testing locations, and sizes of the testing locations. The agricultural intelligence computer system may then generate a prescription map which includes the trial being performed on the testing locations. For example, if the trial is to double the seeding population, the agricultural intelligence computer system may generate the prescription map such that the seeing population for the testing locations is double the population of the remaining locations.

In an embodiment, the agricultural intelligence computer system uses the prescription map to generate one or more scripts that are used to control an operating parameter of an agricultural vehicle or implement. For example, the script may comprise instructions which, when executed by the application controller, cause the application controller to cause an agricultural implement to apply a prescription to the field. The script may include a planting script, nutrient application script, chemical application script, irrigation script, and/or any other set of instructions used to control an agricultural implement.

### 3.8. Benefits of Certain Embodiments

The systems and methods described herein provide a practical application of the utilization of field data to maximize efficient management of an agronomic field using agricultural machinery. By identifying fields with low short length variability, the system can maximize effective use of agricultural land by minimizing area used while providing high statistical value to the results of a test. By identifying a direction of planting and generating the grid overlay and testing locations to be along the direction of planting, the system is able to more efficiently utilize agricultural implement by limiting the number of passes to implement a trial on the field. Finally, by creating a rigid yet flexible grid overlay, the system is able to efficiently identify locations for performing a trial while also maximizing a number of testing locations in a field or management zone.

Additionally, the systems and methods described herein utilize field information as part of a process of physically implementing a trial on an agricultural field using agricultural implements. The methods described herein for identifying testing locations, sizes, and orientations, are performed as part of the process of implementing the agricultural trial. The agricultural intelligence computer system can use the methods described herein to generate a prescription map defining management instructions for the testing locations. Additionally or alternatively, the agricultural intelligence computer system can use the methods described herein to generate one or more scripts which, when executed, cause an agricultural implement to perform specific actions on the agricultural field with different actions being performed at the testing locations.

What is claimed is:

1. A system comprising:
one or more processors;
a memory storing instructions which, when executed by the one or more processors, cause performance of:
receiving, at an agricultural intelligence computing system, a map of a particular agronomic field;
receiving, at the agricultural intelligence computing system, agronomic data for the particular agronomic field;
generating a grid overlay for the map of the agronomic field;
selecting a plurality of sets of adjacent grid cells;
for each set of adjacent grid cells of the plurality of sets of adjacent grid cells, computing a difference value comprising a difference in one or more factors between the grid cells in the set of adjacent grid cells;
computing, from the difference values for each set of adjacent grid cells, a short length variability for the particular agronomic field;
based on the short length variability, selecting one or more locations;
generating a prescription map comprising first management practices for the particular agronomic field and second management practices that are different than the first management practices for the selected one or more locations.

2. The system of claim 1, wherein generating the grid overlay comprises:
identifying a width of an agricultural implement;
generating a first set of parallel lines separated by a distance equal to a multiple of the width of the agricultural implement;
generating a second set of parallel lines perpendicular to the first set of parallel lines.

3. The system of claim 1, wherein selecting a plurality of sets of adjacent grid cells comprises:
randomly or pseudo-randomly selecting a first complete grid cell that is in a single management zone;
selecting a second grid cell from a plurality of grid cells adjacent to the first complete grid cell;
determining if the second grid cell is a complete grid cell that is completely in a same management zone as the first complete grid cell;
if the second grid cell is not a complete grid cell that is completely in the same management zone as the first complete grid cell, discarding the second grid cell and selecting a third grid cell from the plurality of grid cells adjacent to the first complete grid cell;
if the second grid cell is a complete grid cell that is completely in the same management zone as the first complete grid cell, selecting the first grid cell and the second grid cell as a particular set adjacent grid cells.

4. The system of claim 1, wherein the instructions, when executed by the one or more processors, further cause performance of:
receiving yield data and attribute data for a plurality of pairs of adjacent grid cells in a plurality of agronomic fields;
using the yield data and attribute data for the plurality of pairs of adjacent grid cells, computing a plurality of weights which minimize a difference between yield variability of the pairs of adjacent grid cells and attribute variability of the pairs of adjacent grid cells;
wherein the agronomic data received for the particular agronomic field comprises a plurality of attributes but does not comprise past yield values for the particular agronomic field;
wherein computing the difference values for each set of adjacent grid cells of the plurality of sets of adjacent grid cells comprises computing differences in attribute values multiplied by a corresponding weight of the plurality of weights.

5. The system of claim 1, wherein the instructions, when executed by the one or more processors, further cause performance of:
computing a short length variability for a plurality of agronomic fields;
determining that the short length variability for the particular agronomic field is lower than the short length variability of the plurality of agronomic fields and, in response, selecting the particular agronomic field to include the second management practices.

6. The system of claim 1, wherein the instructions, when executed by the one or more processors, further cause performance of:
computing a short length variability for each of a plurality of agronomic fields;
computing a long length variability for each of the plurality of agronomic fields;
for each of the plurality of agronomic fields, computing a variability difference value based, at least in part, on the short length variability and the long length variability for each of the plurality of agronomic fields;
computing a long length variability for the particular agronomic field;
computing a variability difference value for the particular agronomic field based, at least in part, on the short length variability and the long length variability for the particular agronomic field;
determining that the variability difference value for the particular agronomic field is lower than the variability difference value for the plurality of agronomic fields and, in response, selecting the particular agronomic field to include the second management practices.

7. The system of claim 1, wherein the instructions, when executed by the one or more processors, further cause performance of:
determining that a first grid cell in a column of the grid overlay is incomplete;
determining that a first half of the first grid cell is comprises a larger contiguous complete area than a second half of the first grid cell;
shifting the first grid cell and any other grid cells affected by shifting the first grid cell in the direction of the first half of the first grid cell;
determining whether the column comprises more cells after shifting than before shifting;
if the column comprises more cells after shifting than before shifting, updating the grid overlay to include new locations of the first grid cell and the any other grid cells affected by shifting the first grid cell;
if the column does not comprise more cells after shifting than before shifting, reverting the column to a pre-shifted state.

8. The system of claim 1, wherein the instructions, when executed by the one or more processors, further cause performance of:
identifying a first management zone in the map of the agronomic field that has a least number of complete grid cells of the management zones in the map of the agronomic field;
determining that a first grid cell is only partially in the first management zone;
shifting the grid cell and any other grid cells affected by shifting the first grid cell in a direction of a portion of the first grid cell that is in the first management zone;
determining whether the first management zone comprises more cells after shifting than before shifting;
if the first management zone comprises more cells after shifting than before shifting, updating the grid overlay to include new locations of the first grid cell and the any other grid cells affected by shifting the first grid cell;
if the first management zone does not comprise more cells after shifting than before shifting, reverting the cells to a pre-shifted state.

9. The system of claim 1, wherein the instructions, when executed by the one or more processors, further cause performance of generating one or more scripts comprising instructions which, when executed by an application controller of an agricultural implement, cause the application controller to cause the agricultural implement to apply a prescription to the field in accordance with the prescription map.

10. A computer-implemented method comprising:
receiving, at an agricultural intelligence computing system, a map of a particular agronomic field;
receiving, at the agricultural intelligence computing system, agronomic data for the particular agronomic field;
generating a grid overlay for the map of the agronomic field;
selecting a plurality of sets of adjacent grid cells;
for each set of adjacent grid cells of the plurality of sets of adjacent grid cells, computing a difference value comprising a difference in one or more factors between the grid cells in the set of adjacent grid cells;
computing, from the difference values for each set of adjacent grid cells, a short length variability for the particular agronomic field;
based on the short length variability, selecting one or more locations;
generating a prescription map comprising first management practices for the particular agronomic field and second management practices that are different than the first management practices for the selected one or more locations.

11. The computer-implemented method of claim 10, wherein generating the grid overlay comprises:
identifying a width of an agricultural implement;
generating a first set of parallel lines separated by a distance equal to a multiple of the width of the agricultural implement;
generating a second set of parallel lines perpendicular to the first set of parallel lines.

12. The computer-implemented method of claim 10, wherein selecting a plurality of sets of adjacent grid cells comprises:
randomly or pseudo-randomly selecting a first complete grid cell that is in a single management zone;
selecting a second grid cell from a plurality of grid cells adjacent to the first complete grid cell;
determining if the second grid cell is a complete grid cell that is completely in a same management zone as the first complete grid cell;
if the second grid cell is not a complete grid cell that is completely in the same management zone as the first complete grid cell, discarding the second grid cell and selecting a third grid cell from the plurality of grid cells adjacent to the first complete grid cell;
if the second grid cell is a complete grid cell that is completely in the same management zone as the first complete grid cell, selecting the first grid cell and the second grid cell as a particular set adjacent grid cells.

13. The computer-implemented method of claim 10, further comprising:
receiving yield data and attribute data for a plurality of pairs of adjacent grid cells in a plurality of agronomic fields;
using the yield data and attribute data for the plurality of pairs of adjacent grid cells, computing a plurality of weights which minimize a difference between yield variability of the pairs of adjacent grid cells and attribute variability of the pairs of adjacent grid cells;
wherein the agronomic data received for the particular agronomic field comprises a plurality of attributes but does not comprise past yield values for the particular agronomic field;
wherein computing the difference values for each set of adjacent grid cells of the plurality of sets of adjacent grid cells comprises computing differences in attribute values multiplied by a corresponding weight of the plurality of weights.

14. The computer-implemented method of claim 10, further comprising:
computing a short length variability for a plurality of agronomic fields;
determining that the short length variability for the particular agronomic field is lower than the short length variability of the plurality of agronomic fields and, in response, selecting the particular agronomic field to include the second management practices.

15. The computer-implemented method of claim 10, further comprising:
computing a short length variability for each of a plurality of agronomic fields;
computing a long length variability for each of the plurality of agronomic fields;
for each of the plurality of agronomic fields, computing a variability difference value based, at least in part, on the short length variability and the long length variability for each of the plurality of agronomic fields;
computing a long length variability for the particular agronomic field;
computing a variability difference value for the particular agronomic field based, at least in part, on the short length variability and the long length variability for the particular agronomic field;
determining that the variability difference value for the particular agronomic field is lower than the variability difference value for the plurality of agronomic fields and, in response, selecting the particular agronomic field to include the second management practices.

16. The computer-implemented method of claim 10, further comprising:
determining that a first grid cell in a column of the grid overlay is incomplete;
determining that a first half of the first grid cell is comprises a larger contiguous complete area than a second half of the first grid cell;
shifting the first grid cell and any other grid cells affected by shifting the first grid cell in the direction of the first half of the first grid cell;
determining whether the column comprises more cells after shifting than before shifting;
if the column comprises more cells after shifting than before shifting, updating the grid overlay to include new locations of the first grid cell and the any other grid cells affected by shifting the first grid cell;
if the column does not comprise more cells after shifting than before shifting, reverting the column to a pre-shifted state.

17. The computer-implemented method of claim 10, further comprising:
identifying a first management zone in the map of the agronomic field that has a least number of complete grid cells of the management zones in the map of the agronomic field;
determining that a first grid cell is only partially in the first management zone;
shifting the grid cell and any other grid cells affected by shifting the first grid cell in a direction of a portion of the first grid cell that is in the first management zone;
determining whether the first management zone comprises more cells after shifting than before shifting;
if the first management zone comprises more cells after shifting than before shifting, updating the grid overlay to include new locations of the first grid cell and the any other grid cells affected by shifting the first grid cell;
if the first management zone does not comprise more cells after shifting than before shifting, reverting the cells to a pre-shifted state.

18. The method of claim 10, further comprising generating one or more scripts comprising instructions which, when executed by an application controller of an agricultural implement, cause the application controller to cause the agricultural implement to apply a prescription to the field in accordance with the prescription map.
